(19) United States
(12) Patent Application Publication
(10) Pub. No.: US 2009/0260595 A1
(43) Pub. Date: Oct. 22, 2009

(54) Engine and Straddle-Type Vehicle Including the Engine

(75) Inventor: Hideki FUJIWARA, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 12/421,233

(22) Filed: Apr. 9, 2009

(30) Foreign Application Priority Data
Apr. 16, 2008 (JP) 2008-106295

(51) Int. Cl. F02B 75/32; F02F 3/00

(52) U.S. Cl. 123/197.4; 123/193.6

(57) ABSTRACT

An engine that is lighter in weight includes a crankcase, a crankshaft, a body cylinder, a head cylinder, a piston, a piston ring and a cylinder fixing bolt. The piston ring is arranged on an outer peripheral surface of the piston. One end portion of the cylinder fixing bolt extends toward the head cylinder and an other end portion of the cylinder fixing bolt extends toward the crankcase. The cylinder fixing bolt connects the head cylinder, the body cylinder and the crankcase to one another. A lower section of the body cylinder is located within the crankcase. The piston ring abuts on the lower section when the piston is located at a bottom dead center.

### RELATED APPLICATIONS

This application claims the benefit of priority under 35 USC 119 of Japanese patent application no. 2008-106295, filed on Apr. 16, 2008, which is hereby incorporated by reference.

### BACKGROUND OF THE INVENTION

1. Field of the Invention

The present invention relates to an engine and a straddle-type vehicle including the engine.

2. Description of Related Art

FIG. 9 is a cross-sectional view of a typical engine 100 as disclosed in Japanese Patent Application Laid-Open No. 2006-307827. The engine 100 includes a crankcase 101, a body cylinder 102 and a head cylinder 103. As shown in FIG. 9, a piston ring 105 of a piston 104 is normally and always located at a higher position than a position of the crankcase 101. Even when the piston 104 reaches a bottom dead center, the piston ring 105 is located at a position higher than that of the crankcase 101. Due to this, it is necessary to set a length of an upper section 102a that belongs in a head cylinder 103 and is located at a higher position than that of the crankcase 101 to be larger than a stroke length of the piston 104.

Meanwhile, the head cylinder, body cylinder and crankcase are generally joined integrally by a bolt. Therefore, if the distance between the head cylinder and the crankcase is long, as seen in FIG. 9, a longer bolt is required. The engine tends to increase in weight as the bolt is longer.

### SUMMARY OF THE INVENTION

The present invention addresses these issues and provides an engine that is lighter in weight.

An engine according to the present invention comprises a crankshaft accommodated in a crankcase. A connecting rod is connected to the crankshaft. A piston is connected to a tip end portion of the connecting rod. A piston ring is attached to an outer peripheral surface of the piston. A body cylinder is connected to the crankcase and includes a cylinder section inside of which the piston is displaced. A head cylinder is connected to a tip end portion of the body cylinder. A cylinder fixing bolt has one end portion extending toward the head cylinder and an other end portion extending toward the crankcase. The cylinder fixing bolt connects the head cylinder, the body cylinder and the crankcase to one another. The cylinder section of the body cylinder includes a lower section located within the crankcase and an upper section located at a higher position than that of the crankcase. The piston ring abuts on the lower section when the piston is located at-a bottom dead center.

A vehicle according to the present invention includes the engine according to the present invention.

The present invention decreases the weight of the engine.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a left side view of a motorcycle according to an embodiment of the present invention.

FIG. 2 is a left side view of the motorcycle.

FIG. 3 is a cross-sectional view of a part of the engine.

FIG. 4 is a schematic left side view of the engine for explaining fixed states of a crankcase, a body cylinder and a head cylinder.

FIG. 5 is a plan view of a front portion of an upper casing section of the crankcase.

FIG. 6 is a cross-sectional view of the body cylinder showing a piston when located at a bottom dead center.

FIG. 7 is a schematic left side view of the engine in which a sliding section that belongs in the body cylinder and slides with respect to the piston is located at a higher position than a position of the crankcase.

FIG. 8 is a schematic left side view of the engine in which a rear cylinder fixing bolt is overlapped with a casing fixing bolt in a vertical direction.

FIG. 9 is a typical cross-sectional view of an engine of the related art.

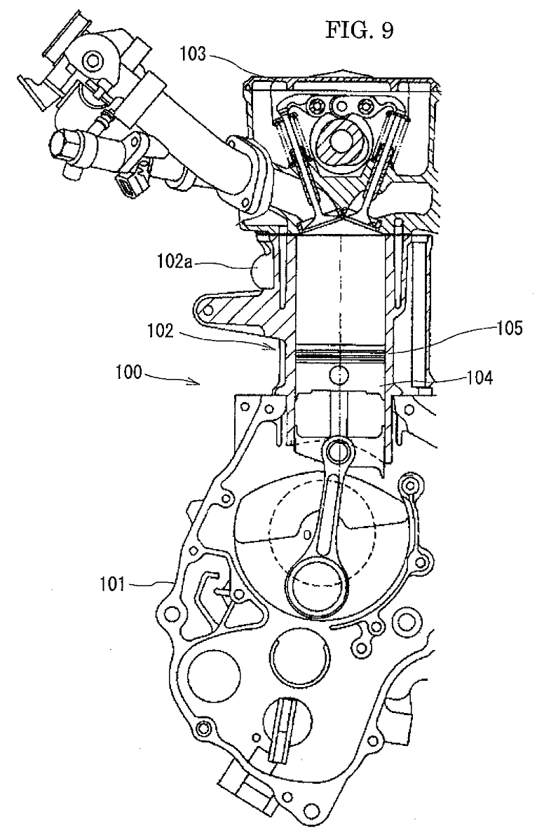

### DETAILED DESCRIPTION OF THE INVENTION

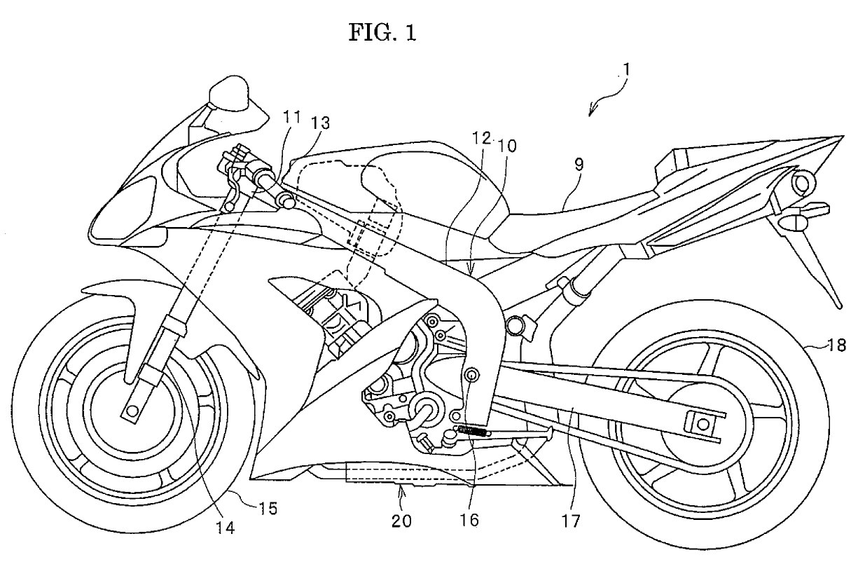

A straddle-type vehicle according to an embodiment of the present invention is now described in detail using motorcycle 1 of FIG. 1 as an example. In the following description, the front-back and left-right directions are from the perspective of a rider seated on a seat 9.

In the present invention, a “straddle-type vehicle” is a vehicle that a rider rides by straddling a seat (saddle) of the vehicle. Examples include a motorcycle, an ATV (All Terrain Vehicle) and a snowmobile. In the present invention, a “motorcycle” is a motorcycle in a broad sense including not only a motorcycle in a narrow sense but also, for example, a moped, an off-road vehicle and a scooter. Therefore, a straddle-type vehicle according to the present invention is not limited to the motorcycle 1 in a narrow sense shown in FIG. 1 and may be a moped, an off-road vehicle, a scooter or the like. In addition, a straddle-type vehicle according to the present invention may be another vehicle such as an ATV or a snowmobile, or a vehicle having at least one front wheel and a plurality of rear wheels, and that is tilted to change a traveling direction.

(Schematic Configuration of Motorcycle 1)

FIG. 1 is a left side view of the motorcycle 1 according to a first embodiment of the present invention. As shown in FIG. 1, the motorcycle 1 includes a body frame 10. The body frame 10 includes a head pipe 11 arranged in a front portion of motorcycle 1 and a main frame 12 extending from the head pipe 11 obliquely rearward and downward.

A steering shaft is rotatably inserted into the head pipe 11. A handle 13 and a pair of front forks 14 are connected to the steering shaft. A front wheel 15 is rotatably attached to lower end portions of the front forks 14. A pivot shaft 16 is attached to a rear portion of the main frame 12. A rear arm 17 is pivotally attached to the pivot shaft 16. A rear wheel 18 is rotatably attached to a rear end portion of the rear arm 17.

(Engine 20)

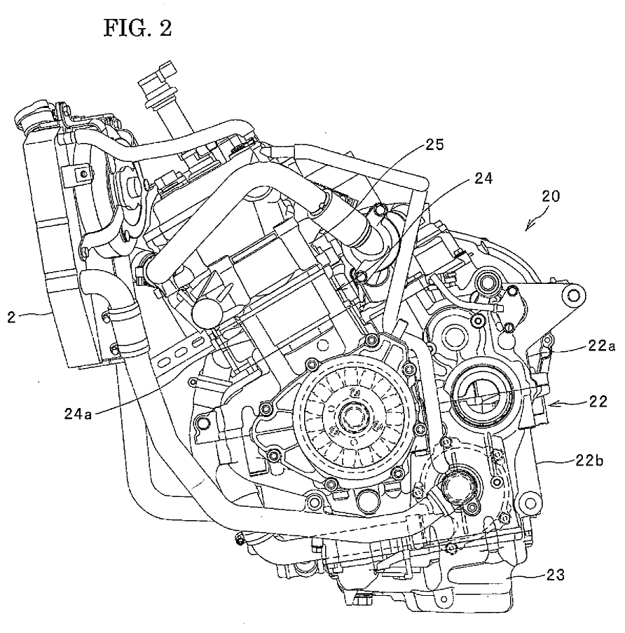

An engine 20 serving as a power source is suspended on the main frame 12. As shown in FIG. 2, a radiator 2 is arranged in front of the engine 20. In this embodiment, the engine 20 is a transverse multiple-cylinder engine, specifically, a water-cooled transverse four-cylinder engine. However, engine 20 is not limited to a specific type and may be, for example, a transverse two-cylinder engine, a transverse three-cylinder engine or a transverse five or more-cylinder engine. Furthermore, the engine may be, for example, a single-cylinder engine, an in-line multiple-cylinder engine, a horizontally-opposed multiple-cylinder engine or a V-type multiple-cylinder engine. The engine may be of an air-cooled type.

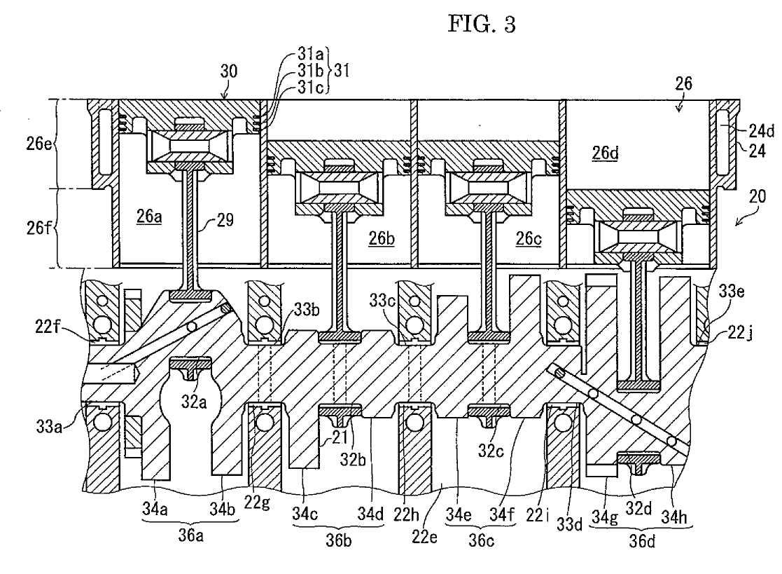

The engine 20 includes a crankshaft 21 (FIG. 3) that extends in a vehicle width direction and is accommodated in a crankcase 22 (FIG. 2). As shown in FIG. 3, the crankshaft 21 includes a first crank web pair 36a; a second crank web pair 36b; a third crank web pair 36c; and a fourth crank web pair 36d, a first crank pin 32a; a second crank pin 32b; a third crank pin 32c; and a fourth crank pin 32d, and a first crank journal 33b; a second crank journal 33c; a third crank journal 33d; a fourth crank journal 33a; and a fifth crank journal 33e.

The first crank web pair 36a is arranged on a leftmost side in FIG. 3 and includes a first crank web 34a and a second crank web 34b. The second crank web 34b is arranged at the right of the first crank web 34a in the vehicle width direction. The first crank web 34a and the second crank web 34b are connected to each other by the first crank pin 32a extending in the vehicle width direction. The fourth crank journal 33a is arranged at the left of the first crank web 34a in the vehicle width direction. The first crank web 34a is connected to the fourth crank journal 33a. The fourth crank journal 33a is supported by a first bearing section 22f formed in the crankcase 22.

The second crank web pair 36b is arranged at the right of the first crank web pair 36a in the vehicle width direction and includes a third crank web 34c and a fourth crank web 34d. The third crank web 34c is arranged at the right of the second crank web 34b in the vehicle width direction. The third crank web 34c is connected to the second crank web 34b by the first crank journal 33b. The first crank journal 33b is supported by a second bearing section 22g formed in the crankcase 22. The fourth crank web 34d is arranged at the right of the third crank web 34c in the vehicle width direction. The third crank web 34c and the fourth crank web 34d are connected to each other by the second crank pin 32b extending in the vehicle width direction.

The third crank web pair 36c is arranged at the right of the second crank web pair 36b in the vehicle width direction and includes a fifth crank web 34e and a sixth crank web 34f. The fifth crank web 34e is arranged at the right of the fourth crank web 34d in the vehicle width direction. The fifth crank web 34e and the fourth crank web 34d are connected to each other by the second crank journal 33c extending in the vehicle width direction. The second crank journal 33c is supported by a third bearing section 22h formed in the crankcase 22. The sixth crank web 34f is arranged at the right of the fifth crank web 34e in the vehicle width direction. The sixth crank web 34f and the fifth crank web 34e are connected to each other by the third crank pin 32c extending in the vehicle width direction.

The fourth crank web pair 36d is arranged at the right of the third crank web pair 36c in the vehicle width direction and includes a seventh crank web 34g and an eighth crank web 34h. The seventh crank web 34g is arranged at the right of the sixth crank web 34f in the vehicle width direction. The seventh crank web 34g and the sixth crank web 34f are connected to each other by the third crank journal 33d extending in the vehicle width direction. The third crank journal 33d is supported by a fourth bearing section 22i formed in the crankcase 22. The eighth crank web 34h is arranged at the right of the seventh crank web 34g in the vehicle width direction. The eighth crank web 34h and the seventh crank web 34g are connected to each other by the fourth crank pin 32d extending in the vehicle width direction.

The fifth crank journal 33e is arranged at the right of the eighth crank web 34h in the vehicle width direction. The eighth crank web 34h is connected to the fifth crank journal 33e. The fifth crank journal 33e is supported by a fifth bearing section 22j formed in the crankcase 22.

The crankcase 22 includes an upper casing section 22a and a lower casing section 22b. The lower casing section 22b is arranged below the upper casing section 22a. A crank chamber 22e, which accommodates the crankshaft 21 and is shown in FIG. 3, is divided by the upper casing section 22a and the lower casing section 22b.

An opening portion open downward is formed in the lower casing section 22b. As shown in FIG. 2, an oil pan 23 is attached to this opening portion of the lower casing section 22b.

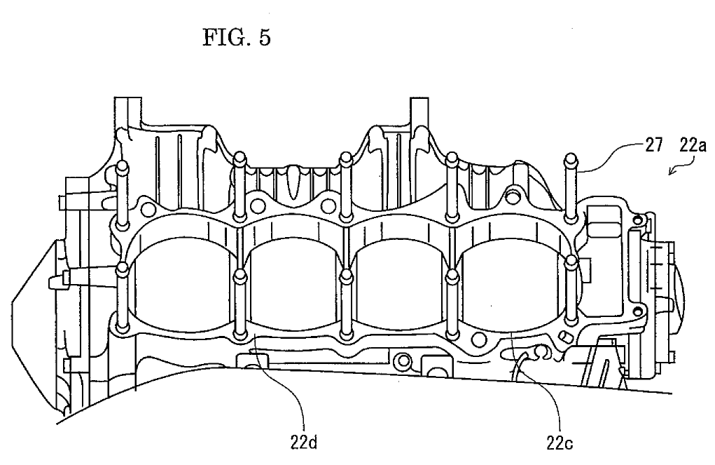

An opening portion 22c (FIG. 5) is formed in a first half part of the upper casing section 22a. A body cylinder 24 (FIG. 2) is attached above the opening portion 22c. A head cylinder 25 is attached to an upper end portion of the body cylinder 24.

As shown in FIG. 3, the body cylinder 24 includes a plurality of cylinder sections 26. Specifically, the body cylinder 24 includes a first cylinder section 26a, a second cylinder section 26b, a third cylinder section 26c and a fourth cylinder section 26d. These four cylinder sections 26a-26d are arranged in the vehicle width direction. In this specification, a “cylinder section” is a section in which a substantially cylindrical space where a piston is displaced is formed. Generally, a body cylinder is formed by one cylinder section or a group of plural cylinder sections.

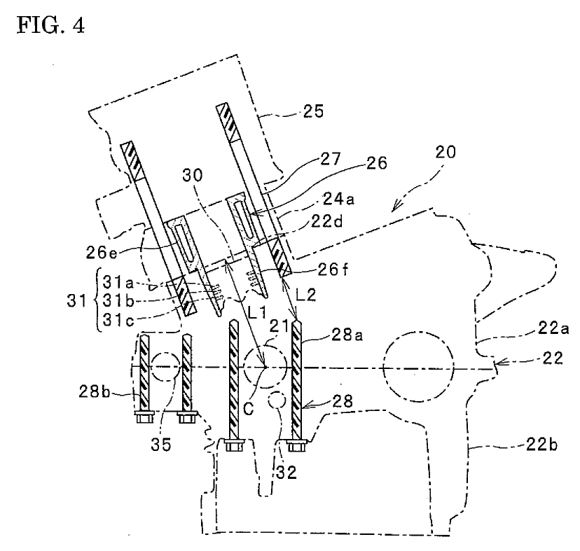

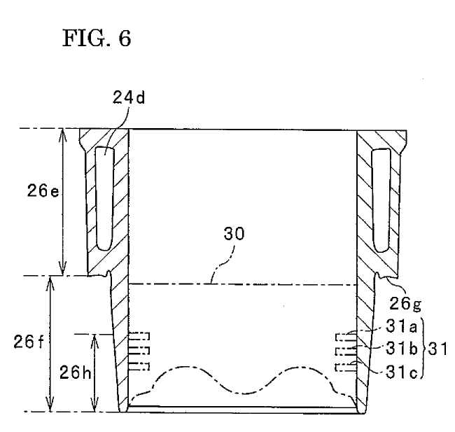

Each of the cylinder sections 26a-26d includes an upper section 26e and a lower section 26f. As shown in FIG. 4, the lower section 26f is located within the crankcase 22. The upper section 26e is arranged at a higher position than a position of the crankcase 22. A lower end portion 26g of the upper section 26e shown in FIG. 6 abuts on a seat surface 22d of the upper casing section 22a shown in FIG. 5. A piston 30 indicated by a chain line in FIG. 4 is located at a bottom dead center. A crankpin 32 indicated by a chain line is a crankpin when the piston 30 is located at the bottom dead center.

In FIG. 4, the cylinder section 26, the piston 30 and the piston ring 31 are drawn to make clearer positional relation among the cylinder section 26, the piston 30, the piston ring 31, the crankcase 22 and the like. Specifically, in FIG. 4, the cylinder section 26, the piston 30 and the piston ring 31 are reduced in size in a direction perpendicular to an axis of the cylinder section 26 so that the cylinder member 26 is not overlapped with a cylinder fixing bolt 27.

As shown in FIG. 6, the upper section 26e is thicker than the lower section 26f. A water jacket 24d to which cooling water is supplied is formed from an upper end portion to a lower end portion of the upper section 26e in an extension direction of a center axis of the cylinder section 26.

A tapered section 26h is formed in a portion downward of a center of the lower section 26f and becomes thinner in a downward direction. Tapered section 26h is arranged toward the crankshaft 21 as compared with the piston ring 31 of the piston 30 located at the bottom dead center. The tapered section 26h is thinner than a portion of the lower section 26f located opposite to the crankshaft 21 with respect to the piston ring 31 of the piston 30 located at the bottom dead center.

As shown in FIG. 3, a slidably displaceable piston 30 is arranged in each of the cylinder sections 26a-26d. The piston 30 is connected to a tip end portion of a connecting rod 29. A proximal end portion of the connecting rod 29 is connected to the crankshaft 21.

As shown in FIGS. 3 and 6, a plurality of piston rings 31 are arranged on an outer peripheral surface of the piston 30. Specifically, a first piston ring 31a, a second piston ring 31b, and a third piston ring 31c are arranged on the outer peripheral surface of the piston 30. These piston rings 31 keep a combustion chamber airtight.

As shown in FIG. 4, the head cylinder 25, the body cylinder 24 and the upper casing section 22a are fixed to one another by a plurality of cylinder fixing bolts 27. In the present embodiment, each of the cylinder fixing bolts 27 is constituted by a stud bolt having screw holes formed on both ends.

As shown in FIG. 5, ten cylinder fixing bolts 27 are arranged in total at the left side of the first cylinder section 26a, at the right side of the fourth cylinder section 26d, and between the cylinder sections 26a to 26b; that is, in front of and in rear of each cylinder section 26.

As shown in FIG. 4, an upper end of each of the cylinder fixing bolts 27 extends toward the head cylinder 25, and a lower end portion of each of the cylinder fixing bolts extends toward the upper casing section 22a. Each of the cylinder fixing bolts 27 is screwed with the head cylinder 25 and the upper casing section 22a.

The upper casing section 22a and the lower casing section 22b are fixed to each other by casing fixing bolts 28. The casing fixing bolts 28 include first casing fixing bolts 28a arranged in front of and in rear of the crankshaft 21, and second casing fixing bolts 28 arranged in front of and in rear of a balancer shaft 35.

As shown in FIG. 4, the cylinder section 26 reaches up to an interior of the crankcase 22. In the present embodiment, when the piston 30 is located at the bottom dead center, the piston ring 31 abuts on the lower section 26f. In other words, when the piston 30 reaches the bottom dead center, the piston ring 31 is located within the crankcase 22. More specifically, when the piston 30 reaches the bottom dead center, the overall piston 30 is substantially located within the crankcase 22. Namely, a sliding section that belongs in the body cylinder 24 and slides with respect to the piston 30 reaches up to the interior of the crankcase 22.

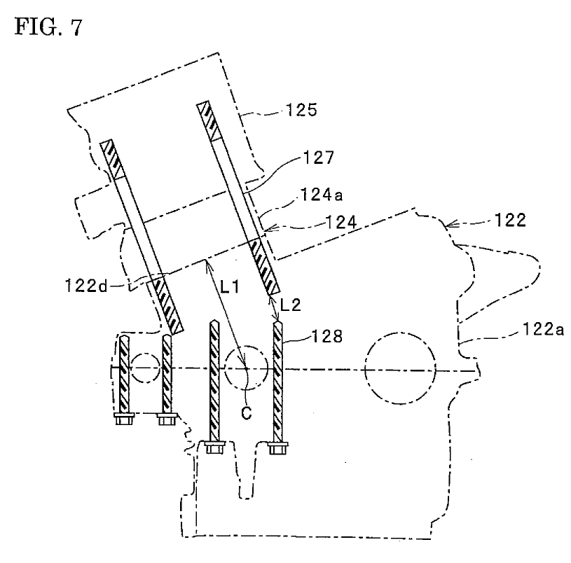

Conventionally, a sliding section that belongs in a body cylinder and slides with respect to a piston is normally provided at a higher position than a position of a crankcase. Due to this, as shown in FIG. 7, an upper section 124a of a body cylinder 124 located above a crankcase 122 is relatively long in a direction of a center axis of a cylinder. Accordingly, a distance between the upper casing section 122a of the crankcase 122 and a head cylinder 125 is relatively long. It is, therefore, necessary to set each cylinder fixing bolt 127 to be relatively long.

According to the present embodiment, by contrast, when the piston 30 is located at the bottom dead center, the piston ring 31 abuts on the lower section 26f as shown in FIGS. 3 and 6. Namely, the sliding section that belongs in the body cylinder 24 and slides with respect to the piston 30 reaches up to the lower section 26f located within the crankcase 22. A length of the upper section 26e located at the higher position than the position of the crankcase 22 in the direction of the center axis of the cylinder section 26 can thereby be made smaller than a stroke length of the piston 30. Accordingly, as shown in FIG. 4, a distance between the head cylinder 25 and the crankcase 22 can be made shorter. As a result, the length of the cylinder fixing bolt 27 can be made shorter, as compared with the case shown in FIG. 7, and engine 20 can be decreased in weight.

As shown in FIG. 4, according to the present embodiment, the crankcase 22 includes the upper casing section 22a and the lower casing section 22b that are connected to each other by the casing fixing bolts 28 extending vertically. Each of the cylinder fixing bolts 27 and each of the casing fixing bolts 28 are thereby arranged to be relatively proximate to each other.

For example, if the sliding section that belongs in the body cylinder 124 and slides with respect to the piston is located at a higher position than that of the crankcase 122 as shown in FIG. 7, a distance L1 between the axis C of the crankshaft and a seat surface 122d of the upper casing section 122a is relatively short. A distance L2 between each cylinder fixing bolt 127 and each casing fixing bolt 128 is thereby relatively short. Accordingly, a high stress is applied onto a portion that belongs in the crankcase 122 and is located between a lower end portion of the cylinder fixing bolt 127 and an upper end portion of the casing fixing bolt 128. It is therefore necessary, for example, to increase the thickness of the portion that belongs in the crankcase 122 and is located between the lower end portion of the cylinder fixing bolt 127 and the upper end portion of the casing fixing bolt 128. However, if the thickness of the portion that belongs in the crankcase 122 and is located between the lower end portion of the cylinder fixing bolt 127 and the upper end portion of the casing fixing bolt 128 is increased, the crankcase 122 tends to increase in weight. Accordingly, the engine 20 increases in weight.

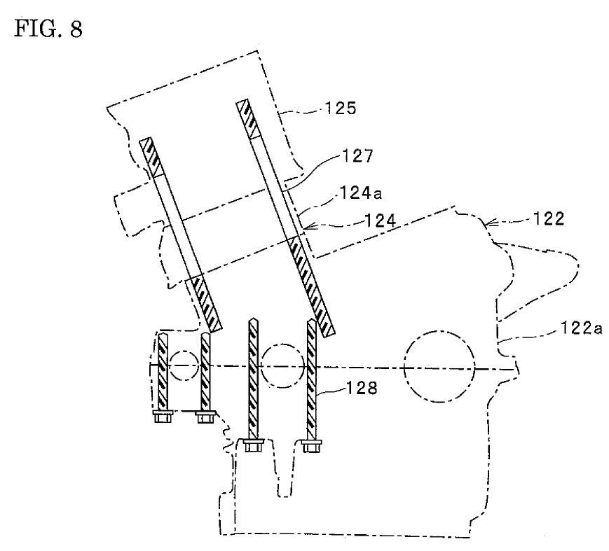

Moreover, as shown in FIG. 8, it is considered that the rear cylinder fixing bolts 127 are extended downward and each cylinder fixing bolt 127 and each casing fixing bolt 128 are overlapped with each other to ensure rigidity of the crankcase 122. However, in this case, each cylinder fixing bolt 127 is made further longer and its weight is further increased. Accordingly, the weight of the engine 20 is possibly further increased.

According to the present embodiment, by contrast, the sliding section that belongs in the body cylinder 24 and slides with respect to the piston 30 is located within the crankcase 22 as shown in FIG. 4. Accordingly, a distance L1 between the seat surface 22d of the upper casing section 22a and the axis C of the crankshaft 21 is relatively long. A distance L2 between the lower end portion of each cylinder fixing bolt 27 and the upper end portion of each casing fixing bolt 28 can thereby be made relatively long. Accordingly, a stress applied onto a portion that belongs in the crankcase 22 and is located between the lower end portion of the cylinder fixing bolt 27 and the upper end portion of the casing fixing bolt 28 is reduced per unit volume. Therefore, there is no need to increase the thickness of the portion that belongs in the crankcase 22 and is located between the lower end portion of the cylinder fixing bolt 27 and the upper end portion of the casing fixing bolt 28, as compared with the case shown in FIG. 7. Moreover, it is unnecessary to vertically overlap each cylinder fixing bolt 27 with each casing fixing bolt 28 as shown in FIG. 8. The engine 20 can thus be further decreased in weight.

As shown in FIG. 6, in the present embodiment, the tapered section 26h is provided in the lower section 26f and is arranged toward the crankshaft 21 as compared with the piston ring 31 of the piston 30 located at the bottom dead center. Further, the tapered section 26h is thinner than the portion of the lower section 26f located toward the head cylinder 25 as compared with the piston ring 31 of the piston 30 located at the bottom dead center. The body cylinder 24 and the engine 20 are thereby even lighter in weight.

The tapered section 26h is located toward the crankshaft 21 as compared with the piston ring 31 of the piston 30 located at the bottom dead center. The rigidity required for the tapered section 26h is thereby not so high as that required for a portion that belongs in the lower section 26f and is located above the tapered section 26h. Moreover, the shape accuracy required for the tapered section 26h is lower than that required for the portion that belongs in the lower section 26f and is located above the tapered section 26h. Due to this, even if the tapered section 26h located toward the crankshaft 21 as compared with the piston ring 31 of the piston 30 located at the bottom dead center is made thinner, no serious problems occur.

1. An engine comprising:
a crankcase;
a crankshaft accommodated in the crankshaft;
a connecting rod connected to the crankshaft;
a piston connected to a tip end portion of the connecting rod;
a piston ring attached to an outer peripheral surface of the connecting rod;
a body cylinder connected to the crankcase, and including a cylinder section inside of which the piston is displaced;
a head cylinder connected to a tip end portion of the body cylinder; and
a cylinder fixing bolt having one end portion extending toward the head cylinder and an other end portion extending toward the crankcase, the cylinder fixing bolt connecting the head cylinder, the body cylinder and the crankcase to one another,
wherein the cylinder section includes:
a lower section located within the crankcase; and
an upper section located at a higher position than a position of the crankcase, and wherein
the piston ring abuts on the lower section when the piston is located at a bottom dead center.

2. The engine according to claim 1, wherein the crankcase includes:
an upper casing section to which the body cylinder is connected; and
a lower casing section connected to a lower side of the upper casing section, and
the engine further comprises a casing fixing bolt for connecting the upper casing section to the lower casing section.

3. The engine according to claim 1, wherein at least a part of a portion of the lower section of the cylinder section that is located toward the crankshaft as compared with the piston ring when the piston is located at the bottom dead center is thinner than a portion of the lower section that is located on an opposite side to the crankshaft with respect to the piston ring when the piston is located at the bottom dead center.

4. The engine according to claim 1, wherein a plurality of the cylinder sections are arranged in the body cylinder in an extension direction of the crankshaft.

5. A straddle-type vehicle comprising the engine according to claim 1.
